(19) United States
(12) Patent Application Publication
(10) Pub. No.: US 2019/0145150 A1
(43) Pub. Date: May 16, 2019

(54) VEHICLE OPENING-CLOSING BODY CONTROL DEVICE AND VEHICLE OPENING-CLOSING BODY CONTROL METHOD

(71) Applicant: AISIN SEIKI KABUSHIKI KAISHA, Kariya-shi (JP)

(72) Inventors: Yasuo KIDENA, Kariya-shi (JP); Takeshi MAEDA, Kariya-shi (JP)

(73) Assignee: AISIN SEIKI KABUSHIKI KAISHA, Kariya-shi (JP)

(21) Appl. No.: 16/180,472

(22) Filed: Nov. 5, 2018

(30) Foreign Application Priority Data
Nov. 15, 2017 (JP) 2017-220047

(51) Int. Cl. E05F 15/73; G06N 99/00

(52) U.S. Cl. CPC E05F 15/73; E05F 15/77; G06N 99/005

(57) ABSTRACT

A vehicle opening-closing body control device controlling a drive unit of an opening-closing body openably and closably supported by a vehicle body of a vehicle via a hinge includes: a storage device storing at least one registered parking area of the vehicle and a target opening degree of the opening-closing body in the registered parking area; and a control unit controlling the drive unit such that the opening-closing body is opened to the target opening degree of the registered parking area in accordance with an opening operation by a user when a host vehicle position of the vehicle is in the registered parking area.

### CROSS REFERENCE TO RELATED APPLICATIONS

This application is based on and claims priority under 35 U.S.C. § 119 to Japanese Patent Application 2017-2017-220047, filed on Nov. 15,2017, the entire contents of which are incorporated herein by reference.

### TECHNICAL FIELD

This disclosure relates to a vehicle opening-closing body control device and a vehicle opening-closing body control method for controlling a drive unit of an opening-closing body openably and closably supported by the vehicle body of a vehicle.

### BACKGROUND DISCUSSION

A door opening-closing control device known in the related art has a camera detecting an obstacle in an imaging region outside a vehicle and restriction means for restricting the opening degree of a door based on a signal from the camera (see, for example, JP 2006-316489A (Reference 1)). In a case where the camera detects no obstacle in the imaging region, the restriction means of the opening-closing control device allows opening of the door such that the operation range of the door is within a range of up to an external terminal of an external mirror. As a result, it is possible to suppress interference with obstacles attributable to the door without being affected by the imaging accuracy of an image captured by the camera.

Also known in the related art is a door opening degree limiting device including a sonar sensor measuring the distance to an obstacle present in a direction in which a vehicle door is opened and an opening degree limiting unit limiting the opening degree distance of the door based on the distance to the obstacle measured by the sonar sensor such that the door does not come into contact with the obstacle (see, for example, JP 2004-034796A (Reference 2)). With the door opening degree limiting device, opening degree adjustment based on door support by an occupant, which is to block contact with an obstacle, does not have to be performed when the obstacle is present that comes into contact with the door when the door is opened to the maximum extent possible.

Also known in the related art is a door opening-closing control device including a door checker of a door check mechanism, a speed sensor measuring the opening-closing speed of a door, a motion conversion mechanism converting a movement of the door checker into a rotational motion, a brake mechanism, a door knob operation detection sensor detecting the operation state of a door knob, a determination circuit making a determination on door knob operation continuation, and a control circuit operating the brake mechanism based on detection signals of the speed sensor and the door knob operation detection sensor and the determination by the determination circuit (see, for example, JP 2016-217031A (Reference 3)). The control circuit of the door opening-closing control device operates the brake mechanism when the opening speed of the door detected by the speed sensor is equal to or greater than a predetermined value or the determination circuit determines that a door knob operation is no longer performed with the door open. As a result, it is possible to prevent the door from coming into contact or colliding with a nearby obstacle even in a place affected by a strong wind or inclination.

According to the techniques described in References 1 and 2, door opening limitation may be delayed and the door may come into contact with obstacles depending on obstacle detection timings. According to the technique described in Reference 3, the brake operates at a point in time when the door knob operation becomes discontinuous, and thus the door may not be sufficiently opened depending on when a user releases his or her hand from the door knob.

Thus, a need exists for a vehicle opening-closing body control device and a vehicle opening-closing body control method which are not susceptible to the drawback mentioned above.

### SUMMARY

A vehicle opening-closing body control device according to an aspect of this disclosure is a vehicle opening-closing body control device controlling a drive unit of an opening-closing body openably and closably supported by a vehicle body of a vehicle via a hinge. The vehicle opening-closing body control device includes a storage device storing at least one registered parking area of the vehicle and a target opening degree of the opening-closing body in the registered parking area and a control unit controlling the drive unit such that the opening-closing body is opened to the target opening degree of the registered parking area in accordance with an opening operation by a user when a host vehicle position of the vehicle is in the registered parking area.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a schematic configuration diagram illustrating a vehicle in which a drive unit according to this disclosure and a vehicle opening-closing body control device controlling the drive unit are mounted;

FIG. 2 is a control block diagram of the vehicle opening-closing body control device according to this disclosure;

FIG. 3 is a flowchart illustrating an example of a door opening degree learning routine executed by the vehicle opening-closing body control device according to disclosure;

FIG. 4 is a flowchart illustrating an example of a door opening control routine executed by the vehicle opening-closing body control device according to the present disclosure; and

FIG. 5 is an explanatory diagram illustrating a door opening control procedure based on the vehicle opening-closing body control device according to this disclosure.

### DETAILED DESCRIPTION

Next, embodiments disclosed here will be explained with reference to accompanying drawings.

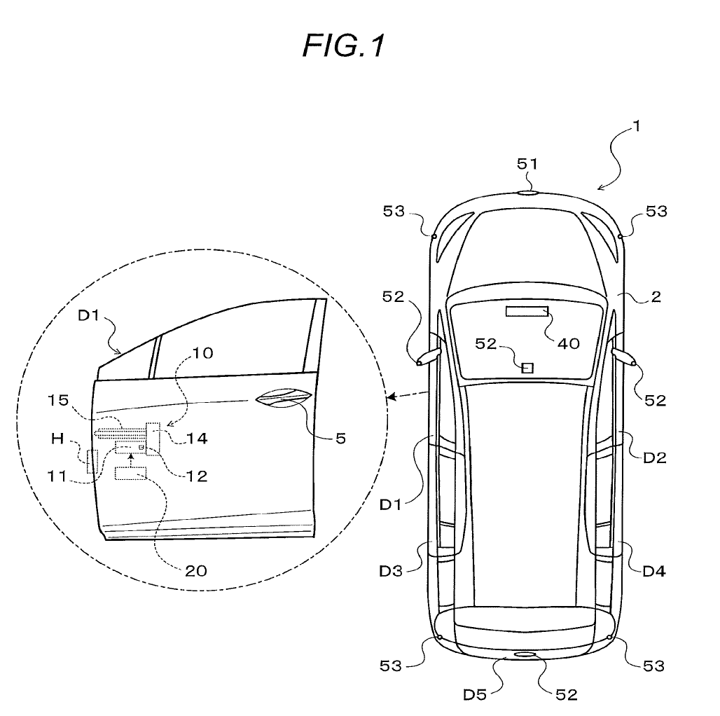

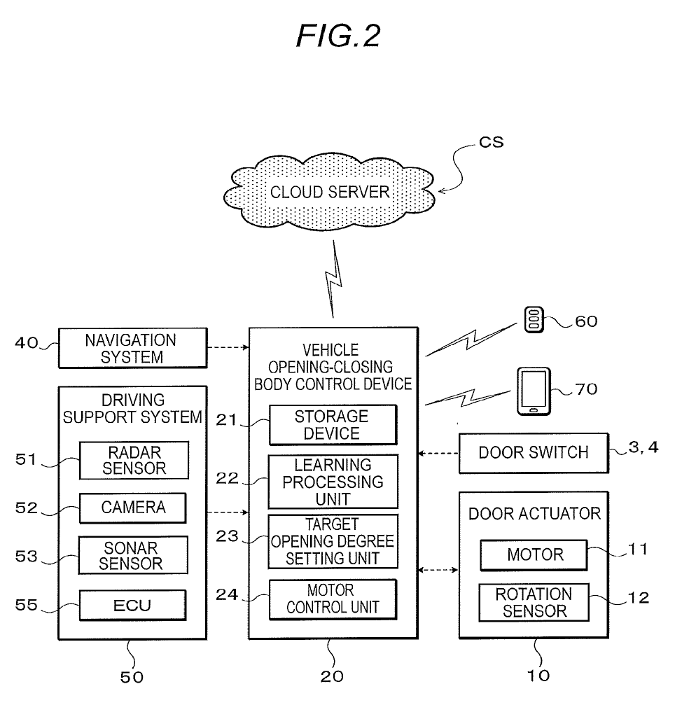

FIG. 1 is a schematic configuration diagram illustrating a vehicle 1 in which a door actuator 10 as a drive unit and a vehicle opening-closing body control device 20 disclosed here controlling the door actuator 10 are mounted, and FIG. 2 is a control block diagram of the vehicle opening-closing body control device 20. The vehicle 1 illustrated in FIG. 1 is a five-door vehicle having left and right front doors D1 and D2, left and right rear doors D3 and D4, and a back door D5, each of which is openably and closably supported by a vehicle body 2 via a hinge H. The door actuator 10 is operated by the vehicle opening-closing body control device 20 in the vehicle 1 when a door switch 3 (see FIG. 2) installed on the armrest of each of the doors D1 to D4, the door handle of the back door D5, and the like is operated by a user. Then, the desired door D1 and the like can be automatically opened and closed. Also, when the user operates an outer door handle 5 or an inner door handle (not illustrated) on the inside of the cabin of the vehicle to disengage a door latch (not illustrated), a door switch 4 (see FIG. 2) incorporated in the doors D1 to D4 and the like is turned on and the door actuator 10 is operated by the vehicle opening-closing body control device 20. Then, the desired door D1 and the like can be automatically opened and closed.

The door actuator 10 is incorporated in the doors D1 to D4 or is disposed between, for example, the vehicle body 2 and the back door D5. As illustrated in FIG. 1, the door actuator 10 includes a motor (DC motor) 11, a non-contact (for example, magnetic) rotation sensor 12 detecting the rotation position of the rotor of the motor 11, a transmission mechanism 14 such as a speed reducer, and a spindle unit 15. The spindle unit 15 includes a housing supported by the corresponding doors D1 to D5 and rotationally driven by the motor 11 via the transmission mechanism 14 and a screw spindle having a tip connected to the corresponding doors D1 to D5 and axially advancing and retracting with respect to the housing as the housing rotates. As a result, by the housing of the spindle unit 15 being rotationally driven by the motor 11, the doors D1 to D5 can be opened and closed to a desired opening degree. The pitch of the screw in the spindle unit 15 is determined such that the doors D1 to D5 smoothly rotate and a satisfactory door check function is ensured when the user manually opens and closes the doors D1 to D5. The door actuator 10 may be provided with, for example, an electromagnetic friction-type brake that decelerates and stops rotation of the rotor of the motor 11.

The vehicle opening-closing body control device 20 includes a microcomputer (not illustrated) having a CPU, a ROM, a RAM, a communication interface, and so on and a storage device 21 such as a nonvolatile memory. The storage device 21 stores, for example, information (ID and position information) about a registered parking area and a target door opening degree θtag of the doors D1 to D5 corresponding to the registered parking area. The registered parking area is a parking area (parking section) where the user frequently parks the vehicle 1, and a parking lot at the user's house or place of work is an example of the registered parking area. The target door opening degree θtag of the registered parking area, which is determined for each of the doors D1 to D5, is an opening degree at which the door D1 or the like is not in contact with a surrounding obstacle or the like when the door D1 or the like of the vehicle 1 parked in the registered parking area is open.

As illustrated in FIG. 2, in the vehicle opening-closing body control device 20, a learning processing unit 22, a target opening degree setting unit 23, and a motor control unit 24 are constructed as functional blocks based on cooperation between various pre-installed programs and hardware such as the CPU, the ROM, the RAM, a switching circuit, and the storage device 21. In a case where the vehicle 1 is parked a predetermined number of times (plurality of times) in the same parking area, the learning processing unit 22 stores the parking area in the storage device 21 as the registered parking area, calculates the target opening degree θtag of the doors D1 to D5 in the registered parking area, and stores the target opening degree θtag in the storage device 21. When the vehicle 1 is parked in a parking area other than the registered parking area, the learning processing unit 22 acquires an opening degree θ of the door D1 or the like opened in the parking area calculated based on a detection value of the rotation sensor 12 of the door actuator 10 and position information about the parking area and stores the acquired parking area position information and opening degree θ of the door D1 or the like in the storage device 21. In a case where the position of the host vehicle is in the registered parking area, the target opening degree setting unit 23 reads the target opening degree θtag corresponding to the host vehicle position from the storage device 21. When the vehicle 1 is parked in a parking area other than the registered parking area and an opening operation on the door D1 or the like is performed by the user, the target opening degree setting unit 23 sets the target opening degree θtag of the door D1 or the like that the user intends to open. The motor control unit 24 controls the motor 11 of the door actuator 10 of each of the doors D1 to D5 based on the target opening degree θtag and so on.

The vehicle opening-closing body control device 20 is connected to a navigation system 40 and a driving support system 50. The navigation system 40 includes a GPS receiver (not illustrated) and so on. The navigation system 40 is capable of specifying the host vehicle position of the vehicle 1. In response to a request from the vehicle opening-closing body control device 20, the navigation system 40 transmits information about the specified host vehicle position to the vehicle opening-closing body control device 20. As illustrated in FIGS. 1 and 2, the driving support system 50 includes a radar sensor 51 installed in the front portion of the vehicle 1, a plurality of cameras 52 installed on, for example, the front window, the left and right side mirrors, and the back door D5 of the vehicle 1, sonar sensors (blind spot sensors) 53 installed at, for example, the four corners of the vehicle 1, and an electronic control unit (hereinafter, referred to as “ECU”) 55 including, for example, a microcomputer having a CPU, a ROM, a RAM, an input-output interface, and so on. The ECU 55 of the driving support system 50 executes various types of driving support control (user support control) such as collision damage mitigation brake control, adaptive cruise control, lane keep assist control, sideslip prevention control, parking support, rear side vehicle detection processing, anti-sudden start control, and processing for detecting a vehicle and an obstacle (including a person) present in a blind spot region (blind spot) based on, for example, signals from the radar sensor 51, the plurality of cameras 52, and the plurality of sonar sensors 53. In a case where the plurality of cameras 52 and the plurality of sonar sensors 53 detect approaching or the like by an obstacle in the blind spot region or around the doors D1 to D5, that is, a person or the like, the driving support system 50 transmits a signal to that effect to the vehicle opening-closing body control device 20.

The vehicle opening-closing body control device 20 is capable of receiving a signal transmitted from a wireless remote control key (smart key) 60. In the present embodiment, the remote control key 60 has an opening switch and a closing switch for opening and closing each of the doors D1 to D5. Once the user operates the opening switch or the like, the vehicle opening-closing body control device 20 controls the door actuator 10 so as to open or close the corresponding door D1 and the like. In the present embodiment, once the opening switch of the remote control key 60 is operated by the user intending to get in the vehicle 1, the vehicle opening-closing body control device 20, the navigation system 40, and the driving support system 50 are started in response to the operation. Then, automatic opening and closing of the doors D1 to D5, specifying of the host vehicle position, detection of an obstacle in, for example, the blind spot region, and the like become executable.

If necessary, the vehicle opening-closing body control device 20 exchanges information with another electronic control unit of the vehicle 1 (such as a transmission-controlling electronic control unit). In addition, the vehicle opening-closing body control device 20 can be linked to a portable terminal 70 such as a smartphone of the user of the vehicle 1. The vehicle opening-closing body control device 20 is capable of communicating with a cloud server CS via the Internet. The cloud server CS has a storage device (database) that stores various types of data (big data) such as the specifications of multiple vehicles including the vehicle 1 (including the door length and the door height of each door). In addition, the cloud server CS acquires, from the multiple vehicles, various types of information such as host vehicle position information about parked vehicles and the opening degrees of open doors of the vehicles.

Next, an operation of the above-described vehicle opening-closing body control device 20 will be described.

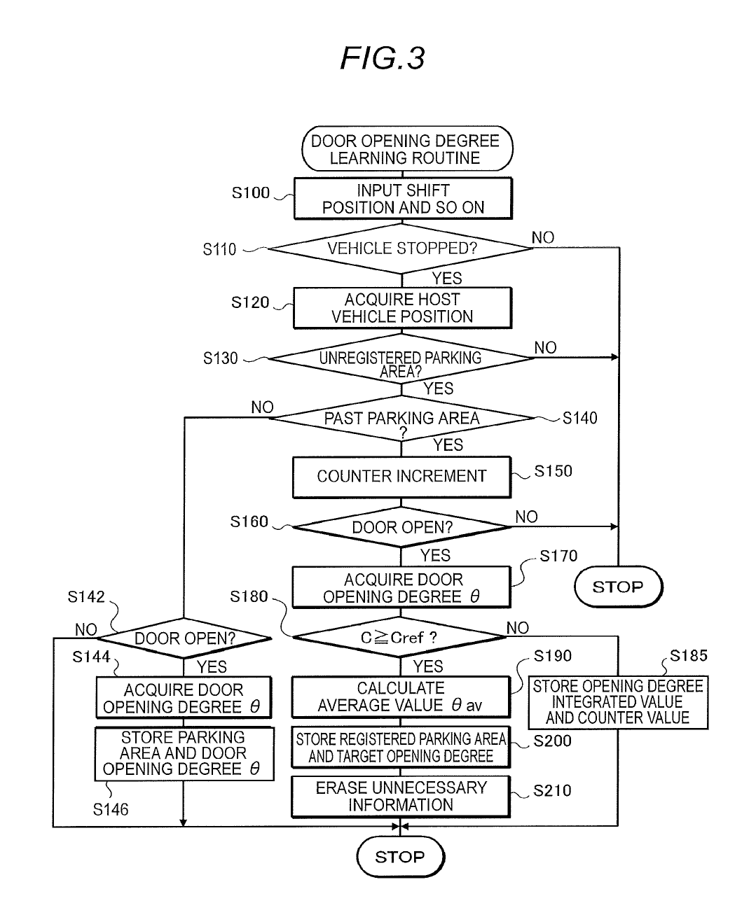

FIG. 3 is a flowchart illustrating an example of a door opening degree learning routine that the vehicle opening-closing body control device 20 executes in order to set the above-described registered parking area and the target opening degree θtag of the door D1 or the like in the registered parking area. The door opening degree learning routine illustrated in FIG. 3 is executed by the learning processing unit 22 of the vehicle opening-closing body control device 20 when the vehicle 1 is stopped.

Upon initiation of the door opening degree learning routine illustrated in FIG. 2, the learning processing unit 22 (CPU) of the vehicle opening-closing body control device 20 inputs a value of a flag indicating the shift position of a shift lever and the operation state of a parking lock device from an electronic control unit controlling the transmission of the vehicle 1 (Step S100) and determines whether or not the vehicle 1 is parked (Step S110). In a case where it is determined in Step S110 that the shift position is a traveling position or the parking lock device does not operate despite the neutral shift position (Step S110: NO), the vehicle opening-closing body control device 20 determines that the vehicle 1 is not parked and terminates this routine at that point in time.

In a case where it is determined in Step S110 that the vehicle 1 is parked (Step S110: YES), the vehicle opening-closing body control device 20 acquires information related to the host vehicle position of the vehicle 1 from the navigation system 40 (or the portable terminal 70) (Step S120) and determines whether or not the host vehicle position of the vehicle 1 is in an unregistered parking area not stored in the storage device 21 as the registered parking area (Step S130). In a case where it is determined in Step S130 that the host vehicle position is the registered parking area (Step S130: NO), the vehicle opening-closing body control device 20 terminates this routine at that point in time.

In a case where it is determined in Step S130 that the host vehicle position is the unregistered parking area (Step S130: YES), the vehicle opening-closing body control device 20 determines whether or not the host vehicle position of the vehicle 1 corresponds to a parking area other than the registered parking area stored in the storage device 21, that is, whether or not the host vehicle position of the vehicle 1 is in a past parking area where the vehicle 1 was parked in the past (Step S140). In a case where it is determined in Step S140 that the host vehicle position is not the past parking area (Step S140: NO), the vehicle opening-closing body control device 20 determines whether or not any of the doors D1 to D5 was opened within a predetermined time from the initiation of this routine (Step S142). In a case where it is determined in Step S142 that none of the doors D1 to D5 was opened within the predetermined time (Step S142: NO), the vehicle opening-closing body control device 20 terminates this routine at that point in time. A negative determination in Step S142 is made in a case where, for example, the vehicle 1 is started again without any occupant getting out after temporary parking of the vehicle 1.

In a case where it is determined in Step S142 that at least one of the doors D1 to D5 was opened within the predetermined time (Step S142: YES), the vehicle opening-closing body control device 20 acquires the opening degree θ of the opened door D1 or the like (Step S144). In a case where the parking area of the vehicle 1 is not the past parking area but a new parking area here, the door D1 and the like are manually opened by the user without being opened by the door actuator 10. During the opening of the door D1 and the like, the vehicle opening-closing body control device 20 inputs the rotation position of the motor 11 detected by the rotation sensor 12 of the door actuator 10 and calculates, in Step S144, the opening degree θ based on the amount of rotation of the rotor of the motor 11 from initiation to stopping of rotation of the door D1 and the like. After acquiring the opening degree θ in Step S144, the vehicle opening-closing body control device 20 stores the host vehicle position-related information acquired in Step S120 in the storage device 21 in association with a provisional ID, a counter (with an initial value of 1), the opening degree θ, and a door identifier (Step S146) and terminates this routine. In the present embodiment, the parking area information and the opening degree θstored in the storage device 21 in Step S146 are deleted from the storage device 21 once a certain period of time elapses without re-parking of the vehicle 1 in the parking area.

In a case where it is determined in Step S140 that the host vehicle position of the vehicle 1 is in the past parking area (Step S140: YES), the vehicle opening-closing body control device 20 increments the counter (Step S150) and determines whether or not any of the doors D1 to D5 was opened within a predetermined time from the initiation of this routine (Step S160). In a case where it is determined in Step S160 that none of the doors D1 to D5 was opened within the predetermined time (Step S160: NO), the vehicle opening-closing body control device 20 terminates this routine at that point in time. In a case where it is determined in Step S160 that at least one of the doors D1 to D5 was opened within the predetermined time (Step S160: YES), the vehicle opening-closing body control device 20 acquires the opening degree θ of the opened door D1 or the like (Step S170) as in Step S144 described above. Further, the vehicle opening-closing body control device 20 determines whether or not the value of the counter is equal to or greater than a predetermined threshold Cref (integer of 2 or more, such as approximately 5) (Step S180). In a case where it is determined in Step S180 that the value of the counter is less than the threshold Cref (Step S180: NO), the vehicle opening-closing body control device 20 calculates the integrated value of the opening degree θ for each of the doors D1 to D5, stores the integrated value of the opening degree θ and the value of the counter in the storage device 21 in association with the past parking area (host vehicle position) (Step S185), and terminates this routine.

In a case where it is determined in Step S180 that the value of the counter is equal to or greater than the threshold Cref (Step S180: YES), the vehicle opening-closing body control device 20 calculates the integrated value of the opening degree θ for each of the doors D1 to D5 and calculates an average opening degree θav of the door D1 or the like at the host vehicle position by dividing the integrated value by the value of the counter (value incremented in Step S150) (Step S190). Subsequently, in order to turn the current host vehicle position (past parking area) of the vehicle 1 into a newly registered parking area, the vehicle opening-closing body control device 20 stores the host vehicle position-related information acquired in Step S120 in the storage device 21 in association with an ID and stores the average opening degree θav calculated in Step S190 in the storage device 21 as the target opening degree θtag in the newly registered parking area (Step S200). Further, the vehicle opening-closing body control device 20 erases unnecessary information (such as the opening degree θ) about the newly registered parking area stored in the storage device 21 until then (Step S210) and terminates this routine.

As described above, in a case where the vehicle 1 is parked a predetermined number of times in the same unregistered parking area, the learning processing unit 22 of the vehicle opening-closing body control device 20 calculates the average opening degree θav (Step S190 in FIG. 3), which is the average value of the opening degree θ of the door D1 or the like opened by the user in the unregistered parking area, stores the unregistered parking area in the storage device 21 as the newly registered parking area, and stores the average opening degree θav in the storage device 21 as the target opening degree θtag of the newly registered parking area (Step S200). As a result, it is possible to store the target opening degree θtag of the door D1 or the like that is appropriate in the storage device 21 in association with the registered parking area even without a special operation from the user of the vehicle 1.

In the vehicle 1 of the present embodiment, the user can register the registered parking area and the target opening degree θtag via, for example, a touch panel-type liquid crystal monitor (not illustrated) installed on an instrument panel. In other words, the user of the vehicle 1 can store information (position information) about the newly registered parking area and the target opening degree θtag of the door D1 or the like in the storage device 21 by performing a registration operation on the registration screen that is displayed on the liquid crystal monitor after parking the vehicle 1 in the parking area registered as the registered parking area and manually opening the door D1 or the like such that the door D1 or the like does not come into contact with an obstacle and the like. Accordingly, in the present embodiment, the registered parking area stored in the storage device 21 and the target opening degree corresponding to the registered parking area include those set by the user.

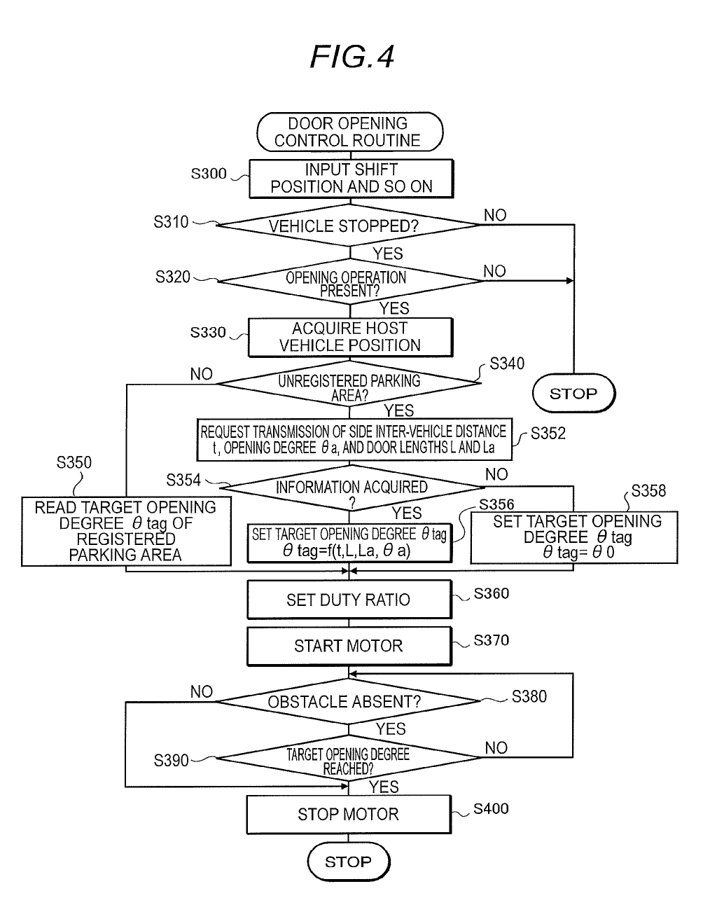

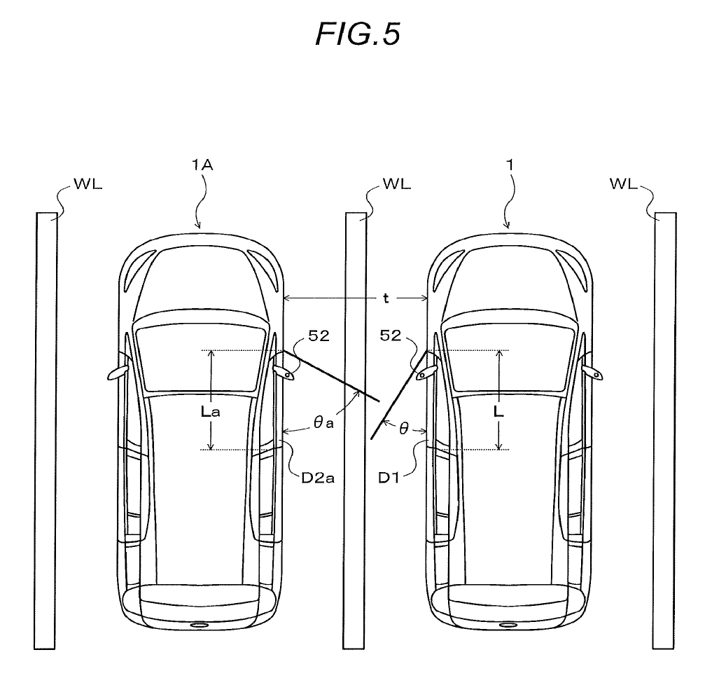

A control procedure at a time when the door D1 or the like is opened by the door actuator 10 being operated will be described below with reference to FIGS. 4 and 5. FIG. 4 is a flowchart illustrating an example of a door opening control routine executed by the vehicle opening-closing body control device 20. The door opening control routine illustrated in FIG. 4 is executed by cooperation between the target opening degree setting unit 23 and the motor control unit 24 of the vehicle opening-closing body control device 20 when the vehicle 1 is stopped. The following description of the door opening control routine illustrated in FIG. 4 will exemplify a case where the door D1 is opened in accordance with a user operation on the door switch 3 or a door knob.

In a case where the routine illustrated in FIG. 4 is initiated with the system of the vehicle 1 started (IGON), the vehicle opening-closing body control device 20 (CPU) inputs a value of a flag indicating the shift position of the shift lever and the operation state of the parking lock device (Step S300). Subsequently, the vehicle opening-closing body control device 20 determines, based on the shift position and so on input in Step S100, whether or not the vehicle 1 is parked (Step S310). In a case where the shift position is a traveling position or the parking lock device does not operate despite the neutral shift position, the vehicle opening-closing body control device 20 determines in Step S310 that the vehicle 1 is not parked (Step S310: NO) and terminates this routine at that point in time. In a case where the system of the vehicle 1 is not started (non-IGON), the shift position is the parking position, or the parking lock device operates with the shift position neutral, the vehicle opening-closing body control device 20 determines in Step S310 that the vehicle 1 is parked (Step S310: YES). In a case where the system of the vehicle 1 is not started in Step S300, the following processing may be executed after input of the shift position and so on input during previous (the most recent) parking of the vehicle 1 and stored in the storage device 21.

In a case where it is determined in Step S310 that the vehicle 1 is parked (Step S310: YES), the vehicle opening-closing body control device 20 determines whether or not an opening operation on the door D1, that is, an operation on the door switch 3 or the like was performed by the user within a predetermined time from the initiation of this routine (Step S320). In a case where it is determined in Step S320 that the opening operation on the door D1 was not performed by the user within the predetermined time (Step S320: NO), the vehicle opening-closing body control device 20 terminates this routine at that point in time. In a case where it is determined in Step S320 that the opening operation on the door D1 was performed by the user (Step S320: YES), the vehicle opening-closing body control device 20 acquires information related to the host vehicle position of the vehicle 1 from the navigation system 40 (or the portable terminal 70) (Step S330). Further, the vehicle opening-closing body control device 20 determines whether or not the host vehicle position of the vehicle 1 is in the unregistered parking area not stored in the storage device 21 as the registered parking area (Step S340).

In a case where it is determined in Step S340 that the host vehicle position is the registered parking area (Step S340: NO), the vehicle opening-closing body control device 20 (target opening degree setting unit 23) reads, from the storage device 21, the target opening degree θtag corresponding to the host vehicle position that is the registered parking area (Step S350). Further, the vehicle opening-closing body control device 20 (motor control unit 24) sets the duty ratio at a time of driving of the motor 11 based on the read target opening degree θtag (Step S360) and starts the motor 11 of the door actuator 10 of the door D1 (Step S370). As a result, the door latch of the door D1 is disengaged by the door actuator 10 and the door D1 begins to open.

After the motor 11 is started, the vehicle opening-closing body control device 20 controls the motor 11 based on the duty ratio set in Step S360 and determines whether or not an obstacle having the possibility of contact with the door D1 (such as a person approaching the door D1) has been detected by the driving support system 50 (Step S380). In a case where it is determined in Step S380 that the obstacle has not been detected by the driving support system 50 (Step S380: YES), the vehicle opening-closing body control device 20 determines, based on the signal from the rotation sensor 12 of the door actuator 10, whether or not the opening degree of the door D1 has reached the target opening degree θtag read in Step S350 (Step S390). In a case where it is determined in Step S390 that the opening degree of the door D1 has not reached the target opening degree θtag (Step S390: NO), the vehicle opening-closing body control device 20 controls the motor 11 and executes the processing of Step S380.

At a point in time when it is determined that the opening degree of the door D1 has reached the target opening degree θtag (Step S390: YES), the vehicle opening-closing body control device 20 stops the motor 11 (Step S400) and terminates this routine. As a result, when the vehicle 1 is parked in the registered parking area, the door D1 can be appropriately opened to the target opening degree θtag by the door actuator 10, with contact with obstacles suppressed, in accordance with a user operation on the door switch 3 or the like. In a case where it is determined in Step S390 that the obstacle has been detected by the driving support system 50, the vehicle opening-closing body control device 20 stops the motor 11 of the door actuator 10 at that point in time (Step S400) and terminates this routine. As a result, contact between an obstacle and the door D1 can be suppressed in a satisfactory manner even in a case where the obstacle suddenly approaches the vehicle 1 or the door D1.

In a case where it is determined in Step S340 that the host vehicle position is the unregistered parking area (Step S340: YES), the vehicle opening-closing body control device 20 (target opening degree setting unit 23) makes a request, with respect to the above-described cloud server CS, for transmission of a side inter-vehicle distance t between the vehicle 1 and an adjacent vehicle 1A parked beside the door D1 of the vehicle 1, a door length L of the door D1 of the vehicle 1, a door length La of a door D2a of the adjacent vehicle 1A positioned beside the door D1 of the vehicle 1, and an opening degree θa of the door D2a of the adjacent vehicle 1A (see FIG. 5 for each) (Step S352). After receiving the information transmission request from the vehicle 1, the cloud server CS acquires host vehicle position-related information and the opening degree θa of the door D2a from the vehicles 1 and 1A and reads, from the storage device (database), information (specifications) such as the door lengths L and La and the vehicle widths and so on of the vehicles 1 and 1A. Further, the cloud server CS calculates the side inter-vehicle distance t between the vehicle 1 and the adjacent vehicle 1A based on the vehicle widths and so on (specifications) of the vehicles 1 and 1A and the acquired information related to the host vehicle positions of the vehicles 1 and 1A and transmits the calculated side inter-vehicle distance t, the door lengths L and La, and the opening degree θa to the vehicle opening-closing body control device 20. In a case where the adjacent vehicle 1A is absent, the cloud server CS sets the side inter-vehicle distance t to an infinite distance and the opening degree θa to 0°. In a case where one or more of the side inter-vehicle distance t, the door lengths L and La, and the opening degree θa cannot be calculated or acquired due to a communication error with respect to the adjacent vehicle 1A, the absence of information, or the like, the cloud server CS transmits a signal indicating that information transmission is impossible to the vehicle opening-closing body control device 20.

After making the information transmission request with respect to the cloud server CS in Step S352, the vehicle opening-closing body control device 20 determines whether or not the requested information could be acquired from the cloud server CS within a predetermined time from the information transmission request (Step S354). In a case where it is determined in Step S352 that the requested information could be acquired from the cloud server CS (Step S354: YES), the vehicle opening-closing body control device 20 sets the target opening degree θtag of the door D1 at which contact between the door D1 and the vehicle body and the door D2a of the adjacent vehicle 1A can be suppressed by putting the side inter-vehicle distance t, the door lengths L and La, and the opening degree θa acquired from the cloud server CS into a predetermined functional formula (Step S356). Further, the vehicle opening-closing body control device 20 executes the processing of Steps S360 to S390 described above, stops the motor 11 of the door actuator 10 in accordance with the result of the determination in Step S380 or S390 (Step S400), and terminates this routine. As a result, when the vehicle 1 is parked in the unregistered parking area other than the registered parking area, the door D1 can be appropriately opened to the target opening degree θtag by the door actuator 10 with contact with obstacles suppressed. Also in this case, contact between an obstacle and the door D1 can be suppressed in a satisfactory manner, by the door actuator 10 (motor 11) being stopped, in a case where the obstacle suddenly approaches the vehicle 1 or the door D1.

In a case where it is determined in Step S354 that the signal indicating that information transmission is impossible was transmitted from the cloud server CS or the requested information could not be acquired from the cloud server CS within the predetermined time due to a communication error or the like (Step S354: NO), the vehicle opening-closing body control device 20 sets a predetermined opening degree θ0 to the target opening degree θtag of the door D1 (Step S 358). In the present embodiment, the opening degree θ0 set to the target opening degree θtag in Step S358 is a relatively small angle, and this is to avoid contact with the adjacent vehicle 1A, a structure, and so on. Subsequently, the vehicle opening-closing body control device 20 executes the processing of Steps S360 to S400 described above, stops the motor 11 of the door actuator 10 in accordance with the result of the determination in Step S380 or S390 (Step S400), and terminates this routine. As a result, when the vehicle 1 is parked in the unregistered parking area other than the registered parking area, the door D1 can be appropriately opened by the door actuator 10 with contact with obstacles suppressed. Also in this case, contact between an obstacle and the door D1 can be suppressed in a satisfactory manner, by the door actuator 10 (motor 11) being stopped, in a case where the obstacle suddenly approaches the vehicle 1 or the door D1.

As described above, the vehicle opening-closing body control device 20 includes the storage device 21 that stores at least one registered parking area of the vehicle 1 and the target opening degree θtag of the doors D1 to D5 in the registered parking area. When the host vehicle position of the vehicle 1 is in the registered parking area, the vehicle opening-closing body control device 20 controls the door actuator 10 such that the door D1 and the like are opened to the target opening degree θtag of the registered parking area in accordance with a user operation (opening operation) on the door switch 3 and the like (Steps S300 to S400 in FIG. 4). Further, the vehicle opening-closing body control device 20 executes the door opening degree learning routine illustrated in FIG. 2 and is capable of storing the target opening degree θtag of the doors D1 to D5 that is appropriate in the storage device 21 in association with the registered parking area even without a special operation from the user of the vehicle 1. In the vehicle 1, the user himself or herself can register the registered parking area and the target opening degree θtag via the liquid crystal monitor (not illustrated) or the like. As a result, the target opening degree θtag of the doors D1 to D5 that is appropriate can be stored in the storage device 21 in association with at least one registered parking area such as a parking lot at the user's house or place of work, and the door D1 and the like can be appropriately opened by the door actuator 10, with contact with obstacles suppressed, in accordance with a user operation on the door switch 3 and the like when the vehicle 1 is parked in the registered parking area.

When the vehicle 1 is parked in the unregistered parking area other than the registered parking area, the vehicle opening-closing body control device 20 (target opening degree setting unit 23) acquires the side inter-vehicle distance t between the vehicle 1 and the adjacent vehicle 1A, the door lengths L and La of the vehicle 1 and the adjacent vehicle 1A, and the opening degree θa of the door D2a of the adjacent vehicle 1A from the cloud server CS (Steps S352 and S354 in FIG. 4). The target opening degree θtag of the door D1 and the like is set based on the information (Step S356). As a result, by the door actuator 10 being controlled such that the door D1 or the like is opened to the target opening degree θtag set in Step S356 (Steps S360 to S400), the door D1 and the like can be appropriately opened by the door actuator 10, with contact with obstacles suppressed, when the vehicle 1 is parked in the unregistered parking area other than the registered parking area. Such an embodiment is particularly useful when combined with parking assist that allows the vehicles 1 and 1A to be parked in the middle of a parking section.

Furthermore, in the above embodiment, the side inter-vehicle distance t, the door lengths L and La, and the opening degree θa are transmitted from the cloud server CS to the vehicle opening-closing body control device 20 in response to a request from the vehicle opening-closing body control device 20 (Steps S352 and S354 in FIG. 4). As a result, a sensor or the like detecting the side inter-vehicle distance t or the like does not have to be installed and the calculation load of the vehicle opening-closing body control device 20 can be reduced. Accordingly, an increase in cost can be suppressed for the vehicle opening-closing body control device 20 and for the vehicle 1 eventually.

The vehicle opening-closing body control device 20 stops the door actuator 10 when an obstacle detection sensor such as the plurality of cameras 52 and the plurality of sonar sensors 53 of the driving support system 50 detects an obstacle having the possibility of contact with the door D1 (such as a person approaching the door D1) while the vehicle opening-closing body control device 20 controls the door actuator 10 for opening of the door D1 and the like (Steps S370 to S400 in FIG. 4). As a result, contact between an obstacle and the door D1 and the like can be suppressed in a satisfactory manner even in a case where the obstacle suddenly approaches the vehicle 1, the door D1, or the like. In the vehicle opening-closing body control device 20, the camera 52 and the sonar sensor 53 of the driving support system 50 are used as obstacle detection sensors, and thus a dedicated sensor or the like does not have to be provided in the vehicle opening-closing body control device 20. As a result, an increase in cost can be suppressed for the vehicle opening-closing body control device 20 and for the vehicle 1 eventually.

In Step S400 of FIG. 4, the door D1 and the like may be closed by the door actuator 10 by means of reverse rotation of the motor 11 instead of stopping of the motor 11, if necessary. In addition, when the opening switch of the remote control key 60 is operated by the user intending to get in the vehicle 1, the processing of Steps S330 to S400 may be executed, and then the door D1 and the like can be opened by the door actuator 10 as in the case of a user operation on the door switch 3 or the door knob immediately following parking of the vehicle 1. In the case of a negative determination in Step S354 of the door opening control routine of FIG. 4, the door actuator 10 is controlled such that the door D1 or the like is opened by the predetermined opening degree θ0. However, the embodiments disclosed here are not limited thereto. In other words, the door opening control routine may be terminated, without the door D1 and the like being opened by the door actuator 10, in the case of a negative determination in Step S354. In addition, the processing of Steps S330 to S350 and S352 to S358 in FIG. 4 may be executed before the determination processing of Step S320 in view of, for example, the speed of communication between the vehicles 1 and 1A and the cloud server CS.

The vehicle opening-closing body control device 20 acquires the side inter-vehicle distance t, the door lengths L and La, and the opening degree θa from the cloud server CS and sets the target opening degree θtag of the door D1 and the like based on the acquired information (Step S356 in FIG. 4). However, the embodiments disclosed here are not limited thereto. In other words, the target opening degree θtag of the door D1 and the like based on the side inter-vehicle distance t, the door lengths L and La, and the opening degree θa may be set in the cloud server CS and the vehicle opening-closing body control device 20 (motor control unit 24) may control the door actuator 10 such that the door D1 and the like are opened to the target opening degree θtag set by the cloud server CS from the cloud server CS. As a result, an increase in cost can be further suppressed for the vehicle opening-closing body control device 20. In addition, the side inter-vehicle distance t may be actually measured or calculated based on a detection value of a sensor provided in the vehicle 1 or the like and information such as the door lengths L and La and the opening degree θa may be exchanged between the vehicle 1 and the adjacent vehicle 1A by so-called inter-vehicle communication.

Also, the vehicle opening-closing body control device 20 may be configured to calculate the vehicle width direction distance from the vehicle 1 to a white line WL (see FIG. 5) of a parking section based on image data acquired by the camera 52 of a side mirror and set the target opening degree θtag of the door D1 and the like from the vehicle width direction distance and a door length. The setting of the target opening degree θtag taking the white line WL into account may be executed in a case where, for example, a negative determination is made in Step S354 of the door opening control routine of FIG. 4 or may be executed in place of the processing of Steps S352 to S356 of FIG. 4.

The embodiments disclosed here are not limited to the above embodiment, and it is a matter of course that various modifications can be made within the scope of extension disclosed here. Furthermore, the above-described embodiment is merely a specific form of the embodiments described in the Summary section and does not limit the elements of the embodiments described in the Summary section.

The embodiments disclosed here can be used in, for example, the vehicle opening-closing body control device manufacturing industry.

A vehicle opening-closing body control device according to an aspect of this disclosure is a vehicle opening-closing body control device controlling a drive unit of an opening-closing body openably and closably supported by a vehicle body of a vehicle via a hinge. The vehicle opening-closing body control device includes a storage device storing at least one registered parking area of the vehicle and a target opening degree of the opening-closing body in the registered parking area and a control unit controlling the drive unit such that the opening-closing body is opened to the target opening degree of the registered parking area in accordance with an opening operation by a user when a host vehicle position of the vehicle is in the registered parking area.

The vehicle opening-closing body control device controls the drive unit such that the opening-closing body is opened to the target opening degree of the registered parking area in accordance with an opening operation from a user when the host vehicle position of the vehicle is in the registered parking area. As a result, it is possible to store an appropriate target opening degree of the opening-closing body in the storage device in association with at least one registered parking area such as a parking lot at a house or a place of work. Accordingly, when the vehicle is parked in the registered parking area, the opening-closing body can be appropriately opened by the drive unit, with contact with obstacles suppressed, in accordance with an opening operation from a user.

The vehicle opening-closing body control device may further include a learning processing unit calculating an average value of opening degrees of the opening-closing body opened by a user in an unregistered parking area, storing the unregistered parking area in the storage device as a newly registered parking area, and storing the average value in the storage device as the target opening degree of the newly registered parking area, in a case where the vehicle is parked a predetermined number of times in the same unregistered parking area. According to this configuration, it is possible to store an appropriate target opening degree of the opening-closing body in the storage device in association with the registered parking area even without a special operation from a vehicle user. The registered parking area and the target opening degree corresponding to the registered parking area stored in the storage device may include a registered parking area and a target opening degree corresponding to the registered parking area which are set by the user.

The vehicle opening-closing body control device may further include a target opening degree setting unit acquiring a side inter-vehicle distance between the vehicle and an adjacent vehicle, lengths of the opening-closing body of the vehicle and an opening-closing body of the adjacent vehicle, and an opening degree of the opening-closing body of the adjacent vehicle and setting the target opening degree of the opening-closing body of the vehicle based on the side inter-vehicle distance, the lengths of the opening-closing bodies, and the opening degree of the opening-closing body of the adjacent vehicle, when the vehicle is parked in a parking area other than the registered parking area. The control unit may control the drive unit such that the opening-closing body of the vehicle is opened to the target opening degree set by the target opening degree setting unit in accordance with an opening operation by a user. According to this configuration, when the vehicle is parked in a parking area other than the registered parking area, the opening-closing body can be appropriately opened by the drive unit with contact with obstacles suppressed.

The vehicle opening-closing body control device may be capable of communicating with a cloud server acquiring a side inter-vehicle distance between the vehicle and an adjacent vehicle, lengths of the opening-closing body of the vehicle and an opening-closing body of the adjacent vehicle, and an opening degree of the opening-closing body of the adjacent vehicle in response to a request from the vehicle parked in a parking area other than the registered parking area. The target opening degree setting unit may acquire the side inter-vehicle distance, the lengths of the opening-closing bodies, and the opening degree of the opening-closing body of the adjacent vehicle from the cloud server. According to this configuration, a sensor or the like does not have to be installed and the calculation load of the vehicle opening-closing body control device can be reduced. Accordingly, an increase in cost can be suppressed for the vehicle opening-closing body control device.

The vehicle opening-closing body control device may be capable of communicating with a cloud server. The cloud server may acquire a side inter-vehicle distance between the vehicle and an adjacent vehicle, lengths of the opening-closing body of the vehicle and an opening-closing body of the adjacent vehicle, and an opening degree of the opening-closing body of the adjacent vehicle in response to a request from the vehicle parked in a parking area other than the registered parking area and set a target opening degree of the opening-closing body of the vehicle based on the side inter-vehicle distance, the lengths of the opening-closing bodies, and the opening degree of the adjacent vehicle. The control unit may control the drive unit such that the opening-closing body of the vehicle is opened to the target opening degree set by the cloud server in accordance with an opening operation from a user. According to this configuration, an increase in cost can be further suppressed for the vehicle opening-closing body control device.

The control unit may control the drive unit such that the opening-closing body is opened by a predetermined opening degree in accordance with an opening operation by a user when the vehicle is parked in a parking area other than the registered parking area.

The vehicle may include an obstacle detection sensor detecting an approaching obstacle, and the control unit may control the drive unit such that the drive unit is stopped or the opening-closing body is closed when the obstacle is detected by the obstacle detection sensor while the drive unit is controlled such that the opening-closing body is opened. As a result, contact between an obstacle and a door can be suppressed in a satisfactory manner even in a case where the obstacle suddenly approaches the vehicle or the opening-closing body. When various sensors of, for example, an in-vehicle driving support system are used as the obstacle detection sensor, a dedicated sensor or the like does not have to be provided in the vehicle opening-closing body control device. According to this configuration, an increase in cost can be suppressed for the vehicle opening-closing body control device and for the vehicle eventually.

A vehicle opening-closing body control method according to an aspect of this disclosure is a vehicle opening-closing body control method for controlling a drive unit of an opening-closing body openably and closably supported by a vehicle body of a vehicle via a hinge. The method includes storing at least one registered parking area of the vehicle and a target opening degree of the opening-closing body in the registered parking area in a storage device and controlling the drive unit such that the opening-closing body is opened to the target opening degree of the registered parking area in accordance with an opening operation by a user when a host vehicle position of the vehicle is in the registered parking area.

According to the method of the aspect of this disclosure, when the vehicle is parked in the registered parking area, the opening-closing body can be appropriately opened by the drive unit, with contact with obstacles suppressed, in accordance with an opening operation from a user.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A vehicle opening-closing body control device controlling a drive unit of an opening-closing body openably and closably supported by a vehicle body of a vehicle via a hinge, comprising:
a storage device storing at least one registered parking area of the vehicle and a target opening degree of the opening-closing body in the registered parking area; and
a control unit controlling the drive unit such that the opening-closing body is opened to the target opening degree of the registered parking area in accordance with an opening operation by a user when a host vehicle position of the vehicle is in the registered parking area.

2. The vehicle opening-closing body control device according to claim 1, further comprising:
a learning processing unit calculating an average value of opening degrees of the opening-closing body opened by a user in an unregistered parking area, storing the unregistered parking area in the storage device as a newly registered parking area, and storing the average value in the storage device as the target opening degree of the newly registered parking area, in a case where the vehicle is parked a predetermined number of times in the same unregistered parking area.

3. The vehicle opening-closing body control device according to claim 1,
wherein the registered parking area and the target opening degree corresponding to the registered parking area stored in the storage device include a registered parking area and a target opening degree corresponding to the registered parking area which are set by a user.

4. The vehicle opening-closing body control device according to claim 1, further comprising:
a target opening degree setting unit acquiring a side inter-vehicle distance between the vehicle and an adjacent vehicle, lengths of the opening-closing body of the vehicle and an opening-closing body of the adjacent vehicle, and an opening degree of the opening-closing body of the adjacent vehicle and setting the target opening degree of the opening-closing body of the vehicle based on the side inter-vehicle distance, the lengths of the opening-closing bodies, and the opening degree of the opening-closing body of the adjacent vehicle, when the vehicle is parked in a parking area other than the registered parking area,
wherein the control unit controls the drive unit such that the opening-closing body of the vehicle is opened to the target opening degree set by the target opening degree setting unit in accordance with an opening operation by a user.

5. The vehicle opening-closing body control device according to claim 4,
wherein the vehicle opening-closing body control device is capable of communicating with a cloud server acquiring a side inter-vehicle distance between the vehicle and an adjacent vehicle, lengths of the opening-closing body of the vehicle and an opening-closing body of the adjacent vehicle, and an opening degree of the opening-closing body of the adjacent vehicle in response to a request from the vehicle parked in a parking area other than the registered parking area, and
the target opening degree setting unit acquires the side inter-vehicle distance, the lengths of the opening-closing bodies, and the opening degree of the opening-closing body of the adjacent vehicle from the cloud server.

6. The vehicle opening-closing body control device according to claim 1,
wherein the vehicle opening-closing body control device is capable of communicating with a cloud server,
the cloud server acquires a side inter-vehicle distance between the vehicle and an adjacent vehicle, lengths of the opening-closing body of the vehicle and an opening-closing body of the adjacent vehicle, and an opening degree of the opening-closing body of the adjacent vehicle in response to a request from the vehicle parked in a parking area other than the registered parking area and sets a target opening degree of the opening-closing body of the vehicle based on the side inter-vehicle distance, the lengths of the opening-closing bodies, and the opening degree of the adjacent vehicle, and
the control unit controls the drive unit such that the opening-closing body of the vehicle is opened to the target opening degree set by the cloud server in accordance with an opening operation from a user.

7. The vehicle opening-closing body control device according to claim 1,
wherein the control unit controls the drive unit such that the opening-closing body is opened by a predetermined opening degree in accordance with an opening operation by a user when the vehicle is parked in a parking area other than the registered parking area.

8. The vehicle opening-closing body control device according to claim 1,
wherein the vehicle includes an obstacle detection sensor detecting an approaching obstacle, and
the control unit controls the drive unit such that the drive unit is stopped or the opening-closing body is closed when the obstacle is detected by the obstacle detection sensor while the drive unit is controlled such that the opening-closing body is opened.

9. A vehicle opening-closing body control method for controlling a drive unit of an opening-closing body openably and closably supported by a vehicle body of a vehicle via a hinge, the method comprising:
storing at least one registered parking area of the vehicle and a target opening degree of the opening-closing body in the registered parking area in a storage device; and
controlling the drive unit such that the opening-closing body is opened to the target opening degree of the registered parking area in accordance with an opening operation by a user when a host vehicle position of the vehicle is in the registered parking area.
